(19) United States
(12) Patent Application Publication
(10) Pub. No.: US 2012/0041142 A1
(43) Pub. Date: Feb. 16, 2012

(54) NANOPARTICLE-MODIFIED HYDROPHILIC POLYISOCYANATES

(76) Inventors: Arno Nennemann, Bergisch Gladbach (DE); Oliver Pyrlik, Leverkusen (DE); Hans-Josef Laas, Odenthal (DE)

(21) Appl. No.: 13/259,311

(22) PCT Filed: Mar. 23, 2010
(86) PCT No.: PCT/EP10/01806

§ 371 Date: Nov. 2, 2011

(30) Foreign Application Priority Data
Mar. 31, 2009 (EP) 09004630.1

(51) Int. Cl. C09D 175/08; C09D 183/00; C09D 7/12; C09D 175/12

(52) U.S. Cl. 524/590; 524/589

(57) ABSTRACT

The present invention relates to novel hydrophilic polyisocyanates which are modified by way of nanoparticles, to a method for producing the same and to the use thereof as a starting component for producing polyurethane plastics, in particular as cross-linkers for water-soluble or water-dispersible lacquer binders or binder components, having groups which can react with isocyanate groups, and to the use thereof in coating agents and adhesives.

The present invention relates to novel hydrophilic polyisocyanates modified by means of nanoparticles, to a process for their preparation and to their use as a starting component in the production of polyurethane plastics, in particular as crosslinkers for water-soluble or water-dispersible lacquer binders or lacquer binder components containing groups reactive towards isocyanate groups, and to their use in coating compositions and adhesives.

Against the background of ever more strict environmental legislation, water-dispersible polyisocyanates have gained importance in recent years for various fields of application. Nowadays they are used in particular as crosslinker components for high-quality water-dilutable two-component polyurethane lacquers (2K PUR lacquers) or as additives for aqueous dispersion adhesives, they serve to crosslink aqueous dispersions in textile finishing or formaldehyde-free textile printing inks and, in addition, they are also suitable, for example, as auxiliary substances for the wet strength treatment of paper (see e.g. EP-A 0 959 087 and literature cited therein).

A large number of different processes are known for the production of water-dispersible polyisocyanates, for example the reaction of hydrophobic polyisocyanates with hydrophilic polyether alcohols (see e.g. EP-B 0 206 059, EP-B 0 540 985 and EP-B 0 959 087), blending and/or reaction with specific hydrophilic polyether urethanes (see e.g. EP-B 0 486 881 and WO 2005/047357), reaction with compounds containing ionic groups (see e.g. WO 01/88006), or the simple blending of hydrophobic polyisocyanates with suitable emulsifiers that are inert towards isocyanate groups (see e.g. WO 97/31960).

From DE 10 2006 054289 and EP 07021690.2 there are known colloidally stable, transparent or translucent nanoparticle-containing polyisocyanates which are obtained by modifying polyisocyanates with aminoalkoxysilanes or with aminoalkoxysilanes and polydimethylsiloxanes and adding nanoparticles. However, hydrophilic polyisocyanates for use in aqueous dispersions are not described. Hydrophilic polyisocyanates are advantageous for use in aqueous dispersions, however, in order to ensure good incorporability as well as homogeneity of the coating.

Accordingly, it was an object of the present invention to provide hydrophilic polyisocyanates in which nano-scale inorganic particles are dispersed. The polyisocyanates so modified, while having as low a solvent content as possible, are to be distinguished by viscosity and agglomeration stability during storage and are to be easily incorporated into aqueous dispersions. It was hereby advantageous to achieve low solvent contents. A further aim was to permit the production, from such polyisocyanates, of haze-free coatings in aqueous applications with advantageous properties by polyol or polyamine crosslinking.

Surprisingly, it has now been found that a partial reaction of isocyanate groups in oligomeric, hydrophilic polyisocyanates with alkoxysilanes results in stable dispersions of inorganic nanoparticles in various polyisocyanates so modified, it also being possible to achieve solids contents of 100% and to use the polyisocyanates so modified in aqueous applications with advantageous properties. Accordingly, the polyisocyanates according to the invention lead to improved anticorrosive properties and a better performance in the salt spray test. Furthermore, they exhibit a smaller relative viscosity increase as compared with hydrophobic nanoparticle-modified polyisocyanates.

Accordingly, the present invention provides a process for the preparation of nanoparticle-modified polyisocyanates, in which

A) hydrophilic polyisocyanates containing at least one ionic and/or non-ionic emulsifier with
polyether units of formula (II)

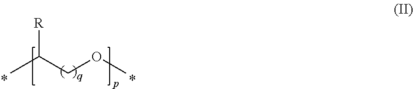

in which
R is hydrogen or a C1- to C10-alkyl radical and
p is a number from 1 to 1000, and
q is from 1 to 3,
and/or sulfonate groups (as SO₃),
and/or phosphate or phosphonate groups (as PO₄ or PO₃),
are reacted with

B) alkoxysilanes of formula (I)

Q-Z-SiXₐY₃₋ₐ (I)
in which
Q is a group reactive towards isocyanates,
X is a hydrolysable group,
Y is identical or different alkyl groups,
Z is a C₁-C₁₂-alkylene group and
a is an integer from 1 to 3,

and then

C) inorganic particles, optionally in surface-modified form, having a mean particle size (Z average), determined by means of dynamic light scattering in dispersion, of less than 200 nm are dispersed therein.

The invention further provides the polyisocyanates or polyisocyanate mixtures so obtainable and the use thereof as a starting component in the production of polyurethane plastics, in particular as a crosslinker component for water-soluble or water-dispersible lacquer binders or lacquer binder components.

Suitable hydrophilic polyisocyanates A) for the preparation of the nanoparticle-modified polyisocyanates according to the invention comprise starting polyisocyanates A1) as well as at least one ionic and/or non-ionic emulsifier D).

Suitable starting polyisocyanates A1) for the preparation of the hydrophilic polyisocyanates A are polyisocyanates having aliphatically, cycloaliphatically, aromatically and/or araliphatically bonded isocyanate groups. Such polyisocyanates are low-monomer polyisocyanates having a uretdione, isocyanurate, allophanate, biuret, iminooxadiazinedione and/or oxadiazinetrione structure which are obtainable by modification of the corresponding diisocyanates, as are described, for example, in J. Prakt. Chem. 336 (1994) 185-200 and EP-A 0 798 299, or arbitrary mixtures of such polyisocyanates. “Low-monomer” in this connection means a residual content of monomeric starting isocyanates of less than 1 wt. %.

The starting polyisocyanates Al) are preferably the mentioned polyisocyanates having solely aliphatically and/or cycloaliphatically bonded isocyanate groups, most particularly preferably polyisocyanates having an isocyanurate structure based on HDI, IPDI and/or 4,4′-diisocyanatodicyclohexylmethane.

For the preparation of the starting polyisocyanates A1) there are used, for example, any desired monomeric diisocyanates and triisocyanates obtainable by phosgenation or by phosgene-free processes, such as, for example, by thermal urethane cleavage. Preferred diisocyanates are those of the molecular weight range from 140 to 400 having aliphatically, cycloaliphatically, araliphatically and/or aromatically bonded isocyanate groups, such as, for example, 1,4-diisocyanatobutane, 1,6-diisocyanatohexane (HDI), 2-methyl-1,5 -diisocyanatopentane, 1,5-diisocyanato-2,2-dimethylpentane, 2,2,4- and 2,4,4-trimethyl-1,6-diisocyanatohexane, 1,10-diisocyanatodecane, 1,3- and 1,4-diisocyanatocyclohexane, 2,4- and 2,6-diisocyanato-1-methylcyclohexane, 1,3- and 1,4-bis-(isocyanatomethyl)-cyclohexane, 1-isocyanato-3,3,5-trimethyl-5-isocyanatomethylcyclohexane (isophorone diisocyanate, IPDI), 4,4′-diisocyanatodicyclohexylmethane, 2,4′-diisocyanatodicyclo-hexylmethane, 1-isocyanato-1-methyl-4(3)isocyanato-methylcyclohexane, bis-(isocyanato-methyl)-norbornane, 1,3- and 1,4-bis-(2-isocyanato-prop-2-yl)-benzene (TMXDI), 2,4- and 2,6-diisocyanatotoluene (TDI), 2,4′- and 4,4′-diisocyanatodiphenylmethane (MDI), 1,5-diisocyanatonaphthalene, or arbitrary mixtures of such diisocyanates.

The starting polyisocyanates A1) are preferably polyisocyanates of the mentioned type having solely aliphatically and/or cycloaliphatically bonded isocyanate groups that have a mean NCO functionality of from 2.0 to 5.0, preferably from 2.3 to 4.5, a content of isocyanate groups of from 8.0 to 27.0 wt. %, preferably from 14.0 to 24.0 wt. %, and a content of monomeric diisocyanates of less than 1 wt. %, preferably less than 0.5 wt. %.

Suitable hydrophilic polyisocyanates A) for the preparation of the nanoparticle-modified polyisocyanates according to the invention contain, in addition to the starting polyisocyanates A1), at least one ionic and/or non-ionic emulsifier D).

Such emulsifiers D) are any desired surface-active substances which, owing to their molecular structure, are capable of stabilising polyisocyanates or polyisocyanate mixtures in aqueous emulsions over a prolonged period.

One type of non-ionic emulsifier D) is, for example, reaction products D1) of the polyisocyanates A1) with hydrophilic polyether alcohols.

Suitable hydrophilic polyether alcohols are mono- or poly-hydric polyalkylene oxide polyether alcohols having, in the statistical mean, from 5 to 50 ethylene oxide units per molecule, as are obtainable in a manner known per se by alkoxylation of suitable starter molecules (see e.g. Ullmanns Encyclopadie der technischen Chemie, 4th Edition, Volume 19, Verlag Chemie, Weinheim p. 31-38). Such starter molecules can be, for example, any desired mono- or di-hydric alcohols of the molecular weight range from 32 to 300, such as, for example, methanol, ethanol, n-propanol, isopropanol, n-butanol, isobutanol, sec-butanol, the isomeric pentanols, hexanols, octanols and nonanols, n-decanol, n-dodecanol, n-tetradecanol, n-hexadecanol, n-octadecanol, cyclohexanol, the isomeric methylcyclohexanols, hydroxymethylcyclohexane, 3-methyl-3-hydroxymethyloxetan, benzyl alcohol, phenol, the isomeric cresols, octylphenols, nonylphenols and naphthols, furfuryl alcohol, tetrahydrofurfuryl alcohol, 1,2-ethanediol, 1,2- and 1,3-propanediol, the isomeric butanediols, pentanediols, hexanediols, heptanediols and octanediols, 1,2- and 1,4-cyclohexanediol, 1,4-cyclohexanedimethanol, 4,4′-(1-methylethylidene)-biscyclohexanol, 1,2,3-propanetriol, 1,1,1-trimethylolethane, 1,2,6-hexanetriol, 1,1,1-trimethylolpropane, 2,2-bis(hydroxymethyl)-1,3-propanediol or 1,3,5-tris(2-hydroxyethyl)-isocyanurate.

Alkylene oxides suitable for the alkoxylation reaction are in particular ethylene oxide and propylene oxide, which can be used in the alkoxylation reaction in any desired sequence or in admixture. Suitable polyether alcohols are either pure polyethylene oxide polyether alcohols or mixed polyalkylene oxide polyethers whose alkylene oxide units consist of at least 70 mol %, preferably at least 80 mol %, ethylene oxide units.

Preferred polyalkylene oxide polyether alcohols are those which have been prepared using as starter molecules the above-mentioned monoalcohols of the molecular weight range from 32 to 150. Particularly preferred polyether alcohols are pure polyethylene glycol monomethyl ether alcohols which contain, in the statistical mean, from 5 to 50, most particularly preferably from 5 to 25, ethylene oxide units.

The preparation of such non-ionic emulsifiers D1) is known in principle and is described, for example, in EP-B 0 206 059 and EP-B 0 540 985.

The preparation can be carried out by reacting the polyisocyanate components A1) with the mentioned polyether alcohols either in a separate reaction step with subsequent mixing with the polyisocyanate components A1) to be converted into a hydrophilic form, or in such a manner that the polyisocyanate components A1) are mixed with an appropriate amount of the polyether alcohols, there spontaneously being formed a hydrophilic polyisocyanate mixture according to the invention which contains, in addition to unreacted polyisocyanate A1), the emulsifier D1) which forms in situ from the polyether alcohol and a portion of component A1).

The preparation of this type of non-ionic emulsifiers DO is generally carried out at temperatures of from 40 to 180° C.., preferably from 50 to 150° C.., while maintaining an NCO/OH equivalent ratio of from 2:1 to 400:1, preferably from 4:1 to 140:1.

In the first-mentioned variant, in which the non-ionic emulsifiers D1) are prepared separately, they are preferably prepared while maintaining an NCO/OH equivalent ratio of from 2:1 to 6:1. In the case of the in situ preparation of the emulsifiers D1), a higher excess of isocyanate groups within the above-mentioned broad range can, of course, be used.

The reaction of the polyisocyanate component A1) with the mentioned hydrophilic polyether alcohols to give non-ionic emulsifiers D1) can also be carried out, according to the process described in EP-B 0 959 087, in such a manner that at least a portion, preferably at least 60 mol %, of the urethane groups formed as primary product by NCO/OH reaction is reacted further to allophanate groups. In that case, the reactants are reacted in the above-mentioned NCO/OH equivalent ratio at temperatures of from 40 to 180° C.., preferably from 50 to 150° C.., generally in the presence of the catalysts suitable for accelerating the allophanatisation reaction that are mentioned in the cited patent specifications.

A further type of suitable non-ionic emulsifiers D) are, for example, reaction products of monomeric diisocyanates or diisocyanate mixtures with the above-mentioned mono- or poly-hydric hydrophilic polyether alcohols, in particular with pure polyethylene glycol monomethyl ether alcohols, which contain, in the statistical mean, from 5 to 50, preferably from 5 to 25, ethylene oxide units. The preparation of such emulsifiers D2) is likewise known and is described, for example, in EP-B 0 486 881.

However, the polyether urethane emulsifiers D2) can optionally also be reacted with the polyisocyanates A1) following the mixing of the components in the above-described relative proportions in the presence of suitable catalysts with allophanatisation. There likewise form hydrophilic polyisocyanate mixtures according to the invention which contain, in addition to unreacted polyisocyanate A1), a further non-ionic emulsifier type D3) having an allophanate structure which is formed in situ from the emulsifier D2) and a portion of component A1). The in situ preparation of such emulsifiers D3) is also already known and is described, for example, in WO 2005/047357.

Instead of the non-ionic emulsifiers described by way of example, the nanoparticle-modified hydrophilic polyisocyanate mixtures according to the invention can also contain emulsifiers containing ionic, in particular anionic, groups.

Such ionic emulsifiers D are sulfonate-group-containing emulsifiers D4), as are obtainable, for example, by the process of WO 01/88006 by reaction of the polyisocyanates A1) with 2-(cyclohexylamino)-ethanesulfonic acid and/or 3-(cyclohexylamino)-propanesulfonic acid. This reaction generally takes place at temperatures of from 40 to 150° C.., preferably from 50 to 130° C.., while maintaining an equivalent ratio of NCO groups to amino groups of from 2:1 to 400:1, preferably from 4:1 to 250:1, tertiary amines being used concomitantly to neutralise the sulfonic acid groups. Suitable neutralising amines are, for example, tertiary monoamines, such as, for example, trimethylamine, triethylamine, tripropylamine, tributylamine, dimethylcyclohexylamine, diisopropylethylamine, N-methylmorpholine, N-ethylmorpholine, N-methylpiperidine or N-ethylpiperidine, tertiary diamines, such as, for example, 1,3-bis-(dimethylamino)-propane, 1,4-bis-(dimethylamino)-butane or N,N′-dimethylpiperazine, or, although less preferred, alkanolamines, such as, for example, dimethylethanolamine, methyldiethanolamine or triethanolamine.

As already described for the non-ionic emulsifiers D1), the preparation of the ionic emulsifiers D4) can also be carried out either in a separate reaction step, with subsequent mixing with the polyisocyanate components A1) to be converted into a hydrophilic form, or in situ in those polyisocyanate components, whereby there is formed directly a hydrophilic polyisocyanate mixture according to the invention which contains, in addition to unreacted polyisocyanate A1), the emulsifier D4) which forms in situ from the aminosulfonic acids, the neutralising amine and a portion of the components A1).

A further type of suitable emulsifiers D) are those which contain ionic and non-ionic structures simultaneously in a molecule. These emulsifiers D5) are, for example, alkylphenol polyglycol ether phosphates and phosphonates or fatty alcohol polyglycol ether phosphates and phosphonates neutralised with tertiary amines, such as, for example, the above-mentioned neutralising amines, as are described, for example, in WO 97/31960 for the hydrophilisation of polyisocyanates, or alkylphenol polyglycol ether sulfates or fatty alcohol polyglycol ether sulfates neutralised with such tertiary amines.

Regardless of the nature of the emulsifier D) and its preparation, the amount thereof, or the amount of ionic and/or non-ionic components added to the polyisocyanates Al) in the case of an in situ preparation of the emulsifier, is generally such that the hydrophilic polyisocyanate mixtures according to the invention that are ultimately obtained contain an amount that ensures the dispersibility of the polyisocyanate mixture, preferably from 1 to 50 wt. %, particularly preferably from 2 to 30 wt. %, based on the total amount of components A1) and D.

In a preferred embodiment there are used as the hydrophilically modified polyisocyanates A) those based on aromatic, araliphatic, cycloaliphatic and/or aliphatic polyisocyanates which have an NCO content of from 5 to 25 wt. % and an NCO functionality 2 and contain at least one polyether unit of formula (II)

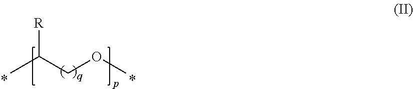

in which

R represents hydrogen or a C1- to C10-alkyl radical, preferably hydrogen or a methyl radical, and

p represents an integer from 1 to 1000, preferably from 1 to 300, and

q represents an integer from 1 to 3,

and/or sulfonate groups (as SO₃) and/or phosphate or phosphonate groups (as PO₄ or PO₃).

Preferably, R is hydrogen or a methyl group and p is from 1 to 300.

The polyether units of formula (H) are preferably bonded to the polyisocyanate skeleton via urethane groups.

The reaction of the starting polyisocyanates A1) with the ionic or non-ionic emulsifiers D) can be carried out without a solvent or optionally in a suitable solvent that is inert towards isocyanate groups. Suitable solvents are, for example, the conventional lacquer solvents known per se, such as, for example, ethyl acetate, butyl acetate, ethylene glycol monomethyl or monoethyl ether acetate, 1-methoxy-2-propyl acetate, 3-methoxy-n-butyl acetate, acetone, 2-butanone, 4-methyl-2-pentanone, cyclohexanone, toluene, xylene, chlorobenzene, white spirit, higher substituted aromatic compounds, as are available commercially under the names solvent naphtha, Solvesso®, Isopar®, Nappar® (Deutsche EXXON CHEMICAL GmbH, Cologne, Del.) and Shellsol® (Deutsche Shell Chemie GmbH, Eschborn, Del.), carbonic acid esters, such as dimethyl carbonate, diethyl carbonate, 1,2-ethylene carbonate and 1,2-propylene carbonate, lactones, such as β-propiolactone, γ-butyrolactone, ε-caprolactone and ε-methylcaprolactone, but also solvents such as propylene glycol diacetate, diethylene glycol dimethyl ether, dipropylene glycol dimethyl ether, diethylene glycol ethyl and butyl ether acetate, N-methylpyrrolidone and N-methylcaprolactam, or arbitrary mixtures of such solvents.

In order to accelerate the reaction, however, conventional catalysts known from polyurethane chemistry can optionally also be used concomitantly in the preparation of the polyisocyanates A), for example tertiary amines such as triethylamine, pyridine, methylpyridine, benzyldimethylamine, N,N-endoethylenepiperazine, N-methylpiperidine, pentamethyldiethylenetriamine, N,N-dimethylaminocyclohexane, N,N′-dimethylpiperazine or metal salts such as iron(III) chloride, aluminium tri(ethylacetoacetate), zinc chloride, zinc(II) n-octanoate, zinc(II) 2-ethyl-1-hexanoate, zinc(II) 2-ethylcaproate, zinc(II) stearate, zinc(II) naphthenate, zinc(II) acetylacetonate, tin(II) n-octanoate, tin(II) 2-ethyl-1-hexanoate, fin(II) ethylcaproate, tin(II) laurate, tin(II) palmitate, dibutyltin(IV) oxide, dibutyltin(IV) dichloride, dibutyltin(IV) diacetate, dibutyltin(IV) dimaleate, dibutyltin(IV) dilaurate, dioctyltin(IV) diacetate, zirconium(IV) 2-ethyl-1-hexanoate, zirconium(IV) neodecanoate, zirconium(IV) naphthenate, zirconium(IV) acetylacetonate, bismuth 2-ethyl-1-hexanoate, bismuth octoate, molybdenum glycolate, or arbitrary mixtures of such catalysts.

Suitable starting components B) for carrying out the process according to the invention are any desired alkoxysilanes of formula (I)

Q-Z-SiXₐY₃₋ₐ (I)

in which Q, Z, X, Y and a have the meaning mentioned above.

Preferred alkoxysilanes are those of formula (I) in which the group X denotes an alkoxy or hydroxy group, particularly preferably methoxy, ethoxy, propoxy or butoxy.

Preferably, Y in formula (I) represents a linear or branched C₁-C₄-alkyl group, preferably methyl or ethyl.

Z in formula (I) is preferably a linear or branched C₁-C₄-alkylene group.

Preferably, a in formula (I) represents 1 or 2.

Preferably, the group Q in formula (I) is a group that reacts with respect to isocyanates to form urethane, urea or thiourea. Such groups are preferably OH, SH or primary or secondary amino groups.

Preferred amino groups correspond to the formula —NHR¹, wherein R¹ is hydrogen, a C₁-C₁₂-alkyl group or a C₆-C₂₀-aryl group, or an aspartic acid ester radical of the formula R²OOC—CH₂—CH(COOR³)— wherein R², R³ are preferably identical or different alkyl radicals, which can optionally also be branched, having from 1 to 22 carbon atoms, preferably from 1 to 4 carbon atoms. Particularly preferably, R², R³ are each methyl or ethyl radicals.

Such alkoxysilane-functional aspartic acid esters are obtainable, as described in U.S. Pat. No. 5,364,955, in a manner known per se by addition of amino-functional alkoxysilanes to maleic or fumaric acid esters.

Amino-functional alkoxysilanes as can be used as compounds of formula (I) or in the preparation of the alkoxysilyl-functional aspartic acid esters are, for example, 2-aminoethyldimethylmethoxysilane, 3-aminopropyltrimethoxysilane, 3-aminopropyltriethoxysilane, 3-aminopropylmethyldimethoxysilane, aminopropylmethyldiethoxysilane.

There can also be used as aminoalkoxysilanes having secondary amino groups of formula (I) in B) N-methyl-3-aminopropyltrimethoxysilane, N-methyl-3-aminopropyltriethoxysilane, N-phenyl-3-aminopropyltrimethoxysilane, bis-(gamma-trimethoxysilylpropyl)-amine, N-butyl-3-aminopropyltrimethoxysilane, N-butyl-3-aminopropyltriethoxysilane, N-ethyl-3-aminoisobutyltrimethoxysilane, N-ethyl-3-aminoisobutyltriethoxysilane or N-ethyl-3-aminoisobutylmethyldimethoxysilane, N-ethyl-3-aminoisobutylmethyldiethoxysilane as well as the analogous C₂-C₄-alkoxysilanes.

Suitable maleic or fumaric acid esters for the preparation of the aspartic acid esters are maleic acid dimethyl ester, maleic acid diethyl ester, maleic acid di-n-butyl ester as well as the corresponding fumaric esters. Maleic acid dimethyl ester and maleic acid diethyl ester are particularly preferred.

The preferred aminosilane for the preparation of the aspartic acid esters is 3-aminopropyltrimethoxysilane or 3-aminopropyltriethoxysilane.

The reaction of the maleic or fumaric acid esters with the aminoalkylalkoxysilanes is carried out within a temperature range of from 0 to 100° C.., the relative proportions generally being so chosen that the starting compounds are used in a molar ratio of 1:1. The reaction can be carried out without a solvent or in the presence of solvents such as, for example, dioxane. The concomitant use of solvents is less preferred, however. Mixtures of different 3-aminoalkylalkoxysilanes can, of course, also be reacted with mixtures of fumaric and/or maleic acid esters.

Preferred alkoxysilanes for the modification of the polyisocyanates are secondary aminosilanes of the above-described type, particularly preferably aspartic acid esters of the above-described type as well as di- and mono-alkoxysilanes.

The above-mentioned alkoxysilanes can be used for the modification individually but also in mixtures.

In the modification, the ratio of free NCO groups of the isocyanate to be modified to the NCO-reactive groups Q of the alkoxysilane of formula (I) is preferably from 1:0.01 to 1:0.75, particularly preferably from 1:0.01 to 1:0.4, most particularly preferably from 1:0.02 to 1:0.2.

Of course, it is also possible in principle to modify higher proportions of NCO groups with the above-mentioned alkoxysilanes, but it must be ensured that the number of free NCO groups available for crosslinking is still sufficient for satisfactory crosslinking.

The reaction of aminosilane and polyisocyanate takes place at from 0 to 100° C.., preferably from 0 to 50° C.., particularly preferably from 15 to 40° C.. Where appropriate, an exothermic reaction can be controlled by cooling.

Of course, the free NCO groups can be modified further following the silane modification of the polyisocyanates so modified. Such a further modification can be, for example, a partial or complete blocking of the free NCO groups using blocking agents of polyurethane chemistry known per se to the person skilled in the art (for the blocking of isocyanate groups see DE-A 10226927, EP-A 0 576 952, EP-A 0 566 953, EP-A 0 159 117, U.S. Pat. No. 4,482,721, WO 97/12924 or EP-A 0 744 423). Suitable blocking agents are, for example, malonic acid diethyl ester, acetoacetic ester, acetone oxime, butanone oxime, methyl ethyl ketoxime, ε-caprolactam, secondary amines as well as triazole and pyrazole derivatives such as, for example, 3,5-dimethylpyrazole, 1,2,4-triazole, dimethyl-1,2,4-triazole, imidazole, diisopropylamine, dicyclohexylamine, N-tert-butyl-benzylamine, cyclopentanone-2-carboxymethyl ester, cyclopentanone-2-carboxyethyl ester or arbitrary mixtures of such blocking agents. Correspondingly blocked polyisocyanate mixtures can be used in combination with the above-mentioned aqueous lacquer binders or lacquer binder components as aqueous one-component PUR baking systems.

In the process according to the invention, the solvents known per se to the person skilled in the art that are inert towards NCO groups can be added in principle at any time. For example, such solvents are solvents such as butyl acetate, methyl ethyl ketone, 1-methoxy-2-propyl acetate, ethyl acetate, toluene, xylene, solvent naphtha as well as mixtures thereof.

During or following the modification of the polyisocyanate, the optionally surface-modified nanoparticles are introduced. This can be carried out simply by stirring in the particles. However, the use of increased dispersing energy is also conceivable, as can be effected, for example, by ultrasound, jet dispersion or high-speed stirrers by the rotor-stator principle. Simple mechanical stirring is preferred.

The particles can in principle be used both in powder form and in the form of suspensions or dispersions in suitable solvents that are preferably inert towards isocyanates. Preference is given to the use of the particles in the form of dispersions in organic solvents, the solvents preferably being inert towards isocyanates.

Solvents suitable for the organosols are methanol, ethanol, isopropanol, acetone, 2-butanone, methyl isobutyl ketone, as well as the solvents conventional per se in polyurethane chemistry, such as butyl acetate, ethyl acetate, 1-methoxy-2-propyl acetate, toluene, 2-butanone, xylene, 1,4-dioxane, diacetone alcohol, N-methylpyrrolidone, dimethylacetamide, dimethylformamide, dimethyl sulfoxide, methyl ethyl ketone, or arbitrary mixtures of such solvents.

Preferred solvents are the solvents conventional per se in polyurethane chemistry, such as butyl acetate, ethyl acetate, 1-methoxy-2-propyl acetate, toluene, 2-butanone, xylene, 1,4-dioxane, diacetone alcohol, N-methylpyrrolidone, dimethylacetamide, dimethylformamide, dimethyl sulfoxide, methyl ethyl ketone, or arbitrary mixtures of such solvents.

Particularly preferred solvents are solvents such as butyl acetate, 1-methoxy-2-propyl acetate, ethyl acetate, toluene, xylene, solvent naphtha (hydrocarbon mixture) as well as mixtures thereof. Ketone solvents such as methyl ethyl ketone are suitable as process solvents but not as solvents for the finished product.

In relation to the content of NCO groups later available for crosslinking, it has been found to be advantageous not to use alcohols either as solvents for the particle dispersions or as process solvents during the polyisocyanate modification because a comparatively higher degradation of NCO groups is here to be observed during storage of the nanoparticle-modified polyisocyanates prepared therefrom. If the polyisocyanates are blocked in an additional step, alcohols can also be used as solvents.

In a preferred embodiment of the invention there are used as particles in C) inorganic oxides, mixed oxides, hydroxides, sulfates, carbonates, carbides, borides and nitrides of elements of main groups II to IV and/or elements of subgroups I to VIII of the periodic system, including the lanthanides. Particularly preferred particles of component C) are silicon oxide, aluminium oxide, cerium oxide, zirconium oxide, niobium oxide and titanium oxide. Silicon oxide nanoparticles are most particularly preferred.

The particles used in C) preferably have mean particle sizes, determined by means of dynamic light scattering in dispersion, as the Z average, of from 5 to 100 nm, particularly preferably from 5 to 50 nm.

Preferably at least 75%, particularly preferably at least 90%, most particularly preferably at least 95% of all the particles used in C) have the sizes defined above.

Preferably, the particles are used in surface-modified form. If the particles used in C) are to be surface-modified, they are reacted, for example, with silanisation prior to being incorporated into the modified polyisocyanate. This method is known in the literature and is described, for example, in DE-A 19846660 or WO 03/44099.

The surfaces can further be modified adsorptively/associatively by means of surfactants having headgroups of corresponding interactions with the particle surfaces or block copolymers, as described, for example, in WO 2006/008120 and Foerster, S. & Antonietti, M., Advanced Materials, 10, no. 3, (1998) 195.

Preferred surface modification is silanisation with alkoxysilanes and/or chlorosilanes. Most particular preference is given to silanes that carry inert alkyl or aralkyl radicals in addition to the alkoxy groups but do not carry further functional groups.

Examples of commercial particle dispersions as are suitable for C) are Organosilicasol™ (Nissan Chemical America Corporation, USA), Nanobyk® 3650 (BYK Chemie, Wesel, Germany), Hanse XP21/1264 or Hanse XP21/1184 (Hanse Chemie, Hamburg, Germany), HIGHLIINK® NanO G (Clariant GmbH, Sulzbach, Germany). Suitable organosols have a solids content of from 10 to 60 wt. %, preferably from 15 to 50 wt. %.

The content of particles used in C) (calculated as solid), based on the total system of modified polyisocyanate and particles, is typically from 1 to 70 wt. %, preferably from 5 to 60 wt. %, particularly preferably from 5 to 40 wt. %, most particularly preferably from 5 to 20 wt. %.

The solids content of nanoparticle-containing PICs according to the invention is from 20 to 100 wt. %, preferably from 60 to 100 wt. %, particularly preferably from 80 to 100 wt. %. A most particularly preferred form yields from 90 to 100%.

If solids contents of 100% are desired for solvent-free polyisocyanates, then the content of particles used in C) (calculated as solid), based on the total system of modified polyisocyanate and particles, is <30 wt. %, preferably <20 wt. %, most particularly preferably <12 wt. %.

The nanoparticle-modified, hydrophilic polyisocyanate mixtures according to the invention are transparent products of the above-mentioned composition, which can optionally also be in dissolved form in solvents, such as, for example, the conventional lacquer solvents mentioned above. They can generally readily be converted into sedimentation-stable dispersions without the use of high shear forces, simply by being stirred into water.

The excellent dispersibility is an advantage in particular for the use of the nanoparticle-modified, hydrophilic polyisocyanates according to the invention in aqueous 2K PUR lacquers, because it is thus possible to obtain highly crosslinked coatings which are additionally distinguished by improvements in their properties brought about by the inorganic nanoparticles. The lacquer films obtainable using the nanoparticle-modified, hydrophilic polyisocyanate mixtures according to the invention are distinguished by high hardness and elasticity, excellent weathering and chemical resistance as well as high gloss. In particular, the scratch resistance in clear lacquers as well as, surprisingly, the corrosion resistance in primers and single-layer covering lacquers are improved by nanoparticle-modified, hydrophilic polyisocyanates according to the invention as compared with the hydrophilic polyisocyanates known hitherto.

Further non-hydrophilised polyisocyanates, in particular lacquer polyisocyanates of the type mentioned above under A1), can optionally be added to the nanoparticle-modified, hydrophilic polyisocyanate mixtures according to the invention before the emulsification, the relative proportions preferably being so chosen that the resulting polyisocyanate mixtures likewise represent nanoparticle-modified, hydrophilic polyisocyanate mixtures according to the invention, because these generally consist of mixtures of

(i) hydrophilic polyisocyanate mixtures modified with nanoparticles according to the invention and

(ii) unmodified polyisocyanates of the type mentioned by way of example.

In such mixtures, the nanoparticle-modified, hydrophilic polyisocyanate mixtures according to the invention act as an emulsifier for the proportion of non-hydrophilic polyisocyanates added subsequently.

The nanoparticle-modified, hydrophilic polyisocyanate mixtures according to the invention are valuable starting materials for the production of polyurethane plastics by the isocyanate polyaddition process.

The invention further provides the nanoparticle-modified polyisocyanates obtainable according to the invention as well as polyurethane systems containing them. Accordingly, the invention also provides coating compositions containing the nanoparticle-modified, hydrophilic polyisocyanate mixtures according to the invention.

In such coating compositions, the hydrophilic polyisocyanate mixtures are preferably used in the form of aqueous emulsions which can be made to react, in combination with polyhydroxyl compounds dispersed in water, in unblocked form as aqueous two-component systems and in a form blocked with blocking agents of the above-mentioned type as aqueous one-component systems.

Particularly preferably, the hydrophilic polyisocyanate mixtures according to the invention are used as crosslinkers for lacquer binders or lacquer binder components dissolved or dispersed in water and having groups reactive towards isocyanate groups, in particular alcoholic hydroxyl groups, in the production of coatings using aqueous coating compositions based on such binders or binder components. The combination of the crosslinker, optionally in emulsified form, with the binders or binder components can be effected by simple stirring prior to processing of the coating compositions by any desired methods, by the use of mechanical aids known to the person skilled in the art, or using two-component spray guns.

In principle, any binders dissolved or dispersed in water and having groups reactive towards isocyanate groups are suitable as reactants for the polyisocyanate mixtures according to the invention.

In this connection the following may be mentioned as examples of lacquer binders or lacquer binder components: hydroxyl-group-containing polyacrylates dissolved or dispersed in water, in particular those of the molecular weight range from 1000 to 10,000 g/mol, which, with organic polyisocyanates as crosslinkers, represent valuable two-component binders, or optionally urethane-modified, hydroxyl-group-containing polyester resins of the type known from polyester and alkyd resin chemistry, dispersed in water. The binders also include, for example, polyurethanes or polyureas dispersed in water, which are crosslinkable with polyisocyanates owing to the active hydrogen atoms present in the urethane or urea groups.

When used according to the invention as a crosslinker component for aqueous lacquer binders, the hydrophilic polyisocyanate mixtures according to the invention are generally used in amounts corresponding to an equivalent ratio of NCO groups to groups that are reactive towards NCO groups, in particular alcoholic hydroxyl groups, of from 0.5:1 to 2:1.

The hydrophilic polyisocyanate mixtures according to the invention can optionally also contain minor amounts of non-functional aqueous lacquer binders in order to achieve very specific properties, for example as an additive for improving adhesion.

As substrates for the aqueous coatings formulated with the aid of the hydrophilic polyisocyanate mixtures according to the invention there come into consideration any desired substrates, such as, for example, metal, wood, glass, stone, ceramic materials, concrete, rigid and flexible plastics, textiles, leather and paper, which can optionally also be provided with conventional primers prior to coating.

In general, the aqueous coating compositions formulated with the coating compositions according to the invention, to which there can optionally be added auxiliary substances and additives conventional in the lacquers sector, such as, for example, flow aids, colouring pigments, fillers, mattifying agents, inorganic or organic pigments, light stabilisers, lacquer additives, such as dispersing agents, flow agents, thickeners, antifoams and other auxiliary substances, adhesion promoters, fungicides, bactericides, stabilisers or inhibitors and catalysts or emulsifiers, possess good lacquer properties even when dried at room temperature.

As auxiliary substances and additives there can be used solvents such as butyl acetate, ethyl acetate, 1-methoxy-2-propyl acetate, toluene, 2-butanone, xylene, 1,4-dioxane, diacetone alcohol, N-methylpyrrolidone, dimethylacetamide, dimethylformamide, dimethyl sulfoxide or arbitrary mixtures of such solvents. Preferred solvents are butyl acetate, 2-ethyl acetate and diacetone alcohol.

Of course, they can also be dried under forced conditions at elevated temperature or by baking at temperatures of up to 260° C..

In addition to the preferred use as crosslinker components for aqueous 2K PUR lacquers, the nanoparticle-modified, hydrophilic polyisocyanate mixtures according to the invention and the polyurethane systems based thereon are suitable generally for the production of polyurethane adhesives, polyurethane lacquers and polyurethane coatings and are excellently suitable as crosslinkers for aqueous dispersion adhesives, leather and textile coatings or textile printing pastes, as AOX-free paper additives or also as additives for mineral building materials, for example concrete or plaster compositions.

The polyurethane systems according to the invention are applied to substrates by the application processes conventional in coating technology, such as, for example, spraying, flooding, dipping, spin coating or doctor blade application.

### EXAMPLES

Unless indicated otherwise, percentages are to be understood as being percent by weight.

The hydroxyl number (OH number) was determined according to DIN 53240-2.

The viscosity was determined by means of a “RotoVisco 1” rotary viscometer from Haake, Germany according to DIN EN ISO 3219/A.3.

The acid number was determined according to DIN EN ISO 2114.

The colour index (APHA) was determined according to DIN EN 1557.

The NCO content was determined according to DIN EN ISO 11909.

The residual monomer content was determined according to DIN EN ISO 10 283.

Butoxyl: abbreviation for 3-methoxy-n-butyl acetate

Organosilicasol™ MEK-ST: colloidal silica dispersed in methyl ethyl ketone, particle size 10-15 nm, 30 wt. % SiO₂, <0.5 wt. % H₂O, <5 mPa s viscosity, Nissan Chemical America Corporation, USA

Dynasylan® 1189: N-(n-butyl)-3-aminopropyltrimethoxysilane, Degussa/Evonik AG, Germany

Surfynol® 104 BC: non-ionic surface-active surfactant, AirProducts, Germany

Borchigel® PW 25: thickener, OMG Borchers GmbH, Germany

Baysilone® LA 200: antifoam/deaerating agent, OMG Borchers GmbH, Germany

Baysilone® 3468: wetting agent, OMG Borchers GmbH, Germany

Borchigen® SN 95: wetting and dispersing additive, OMG Borchers GmbH, Germany

Tronox® R-KB-4: titanium dioxide pigment, Tronox Inc., Germany

Tinuvin® 292, 1130: light stabilisers, Ciba AG, Switzerland

Dynasylan® GLYMO: 3-glycidyloxypropyltrimethoxysilane, Degussa/Evonik AG, Germany

Bayhydrol® XP 2470: water-dilutable, OH-functional polyacrylate dispersion, delivery form approximately 45% in water/Solvent Naphtha® 100/Dowanol® PnB, neutralised with dimethylethanolamine/triethanolamine, viscosity at 23° C.. 2000 ±500 mPa·s, OH content approximately 3.9%, acid number approximately 10 mg KOH/g (Bayer MaterialScience AG/Leverkusen, Germany)

Bayhydrol® XP 2645: water-dilutable, OH-functional polyacrylate dispersion, delivery form approximately 43% in water/Solvent Naphtha 100/Dowanol® PnB, neutralised with dimethylethanolamine, viscosity at 23° C.. 500-4000 mPa·s, OH content approximately 4.5%, acid number approximately 9 mg KOH/g (Bayer MaterialScience AG/Leverkusen, Germany)

Bayhydrol® XP 2695: water-dilutable, OH-functional polyacrylate dispersion, delivery form approximately 41% in water/1-butoxy-2-propanol, neutralised with triethanolamine/dimethylethanolamine (3:1), viscosity at 23° C.. approximately 2500 mPa·s, OH content approximately 5.0%, acid number approximately 9.4 mg KOH/g (Bayer MaterialScience AG/Leverkusen, Germany)

### Determination of the Particle Size

The particle sizes were determined by means of dynamic light scattering using an HPPS particle size analyzer (Malvern, Worcestershire, UK). Evaluation was made using Dispersion Technology Software 4.10. In order to avoid multiple scattering, a highly dilute dispersion of the nanoparticles was prepared. A drop of a dilute nanoparticle dispersion (approximately 0.1-10%) was placed in a cuvette containing approximately 2 ml of the same solvent as the dispersion, shaken and measured in the HPPS analyzer at 20 to 25° C.. As generally known to the person skilled in the art, the relevant parameters of the dispersing medium—temperature, viscosity and refractive index—were entered into the software beforehand. In the case of organic solvents, a glass cuvette was used. An intensity or volume/particle diameter curve as well as the Z average for the particle diameter was obtained as the result. It was ensured that the polydispersity index was <0.5.

Pendulum damping (König) according to DIN EN ISO 1522 “Pendulum damping test”

Scratch resistance laboratory car-wash (wet scratching) according to DIN EN ISO 20566 “Paints and varnishes—Determination of the scratch resistance of a coating system using a laboratory car-wash”

Gloss/haze measurement according to DIN EN ISO 13803 “Determination of the reflection haze of coatings at 20°” and DIN EN ISO 2813 “Determination of the reflectometer value of coatings”

### Determination of Solvent Resistance

By means of this test, the resistance of a cured lacquer film to various solvents was determined. To that end, the solvents are allowed to act on the lacquer surface for a specific time. Then an assessment is made, visually and by touch, of whether and what changes have occurred on the test surface. The lacquer film is generally on a glass sheet, although other substrates are also possible. The test tube stand containing the solvents xylene, 1-methoxy-2-propyl acetate, ethyl acetate and acetone (see below) is placed on the lacquer surface so that the openings of the test tubes with the cotton wool plugs lie on the film. It is important that the lacquer surface is thereby wetted with the solvent. After the specified exposure time to the solvents of 1 minute and 5 minutes, the test tube stand is removed from the lacquer surface. The solvent residues are then immediately removed by means of absorbent paper or textile fabric. After careful scratching with a fingernail, the test surface is then immediately checked visually for changes. A distinction is made between the following stages:

0=unchanged

1=trace changed e.g. only visible change

2=slightly changed e.g. softening perceptible with the fingernail detectable

3=markedly changed e.g. pronounced softening detectable with the fingernail

4=considerably changed e.g. with the fingernail to the substrate

5=destroyed e.g. lacquer surface destroyed without external influence

The ratings found for the solvents indicated above are documented in the following sequence:

| | |
|---|---|
| Example | 0000 (no change) |
| Example | 0001 (visible change only in the case of acetone) |

The numerical sequence follows the sequence of the solvents tested (xylene, methoxypropyl acetate, ethyl acetate, acetone).

Determination of Scratch Resistance by Means of the Hammer Test (Dry Scratching)

Scratching is carried out using a hammer (weight: 800 g without handle) to the flat side of which steel wool 00 is fastened. To that end, the hammer is carefully placed at a right angle on the coated surface and guided in a path over the coating without being tilted and without additional body weight. 10 to-and-fro strokes are carried out. After exposure to the scratching medium, the test surface is cleaned with a soft cloth and then the gloss is measured transversely to the direction of scratching according to DIN EN ISO 2813. Only homogeneous regions may be measured. Information regarding scratching is usually given as % retention or loss of gloss relative to the starting gloss.

Condensation water test according to DIN EN ISO 6270/2 CH “Paints and varnishes—Determination of resistance to humidity”

Salt spray test according to DIN EN ISO 9227 NSS: “Corrosion tests in artificial atmospheres—Salt spray tests”

Evaluation of damage in each case according to DIN EN ISO 4628 “Paints and varnishes—Evaluation of degradation of coatings—Designation of quantity and size of defects, and of intensity of uniform changes in appearance”

Weathering (CAM 180): UV accelerated weathering according to SAE J2527 CAM 180 “Performance Based Standard for Accelerated Exposure of Automotive Exterior Materials Using a Controlled Irradiance Xenon-Arc Apparatus”

### Starting Polyisocyanate A)-1 Containing Emulsifier Type D4):

A mixture of 400 g (2.07 val) of an isocyanurate-group-containing polyisocyanate based on 1,6-diisocyanatohexane (HDI) having an NCO content of 21.7%, a mean NCO functionality of 3.5 (according to GPC), a content of monomeric HDI of 0.1% and a viscosity of 3000 mPas (23° C..) and 600 g (3.36 val) of an HDI-based iminooxadiazinedione-group-containing polyisocyanate having an NCO content of 23.5%, a mean NCO functionality of 3.1 (according to GPC), a content of monomeric HDI of 0.2% and a viscosity of 700 mPas (23° C..) is stirred for 10 hours at 80° C., under dry nitrogen, together with 30 g (0.14 val) of 3-(cyclohexylamino)-propanesulfonic acid (CAPS) and 18 g (0.14 mol) of dimethylcyclohexylamine. After cooling to room temperature, a virtually colourless, clear polyisocyanate mixture having the following characteristic data is obtained:

| | |
|---|---|
| Solids content: | 100% |
| NCO content: | 21.2% |
| NCO functionality: | 3.2 |
| Viscosity (23° C.): | 3500 mPas |
| Colour index: | 60 APHA |

### Starting Polypolyisocyanatetype A)-2 Containing Emulsifier Type D1):

870 g (4.50 val) of the isocyanurate-group-containing, HDI-based polyisocyanate described in the preparation of starting polyisocyanate A)-1 are placed in a reaction vessel at 100° C.., under dry nitrogen and with stirring; in the course of 30 minutes, 130 g (0.37 val) of a methanol-started, monofunctional polyethylene oxide polyether having a mean molecular weight of 350 are added and stirring is continued at that temperature until the NCO content of the mixture has fallen after about 2 hours to a value of 17.4%. After cooling to room temperature, a colourless, clear polyisocyanate mixture having the following characteristic data is obtained:

| | |
|---|---|
| Solids content: | 100% |
| NCO content: | 17.4% |
| NCO functionality: | 3.2 |
| Viscosity (23° C.): | 2800 mPas |
| Colour index: | 40 APHA |

### Starting Polyisocyanate A)-3 Containing Emulsifier Type D3):

910 g (4.70 val) of the isocyanurate-group-containing, HDI-based polyisocyanate described in the preparation of starting polyisocyanate A)-1 are placed in a reaction vessel at 100° C., under dry nitrogen and with stirring; in the course of 30 minutes, 90 g (0.18 val) of a methanol-started, monofunctional polyethylene oxide polyether having a mean molecular weight of 500 are added and then stirring is continued at that temperature until the NCO content of the mixture has fallen after about 2 hours to the value of 18.7%, corresponding to complete urethanisation. 0.01 g of zinc(II) 2-ethyl-1-hexanoate is then added as allophanatisation catalyst. The temperature of the reaction mixture thereby rises to 106° C. owing to the heat of reaction that is released. When the heat of reaction has subsided, about 30 minutes after addition of the catalyst, the reaction is terminated by addition of 0.01 g of benzoyl chloride and the reaction mixture is cooled to room temperature. A virtually colourless, clear polyisocyanate mixture having the following characteristic data is obtained:

| | |
|---|---|
| Solids content: | 100% |
| NCO content: | 18.2% |
| NCO functionality: | 3.5 |
| Viscosity (23° C.): | 4000 mPas |
| Colour index: | 60 APHA |

### Starting Polyisocyanate A)-4 Containing Emulsifier Type D3):

According to the process described for starting polyisocyanate A)-3, 860 g (4.44 val) of the isocyanurate-group-containing, HDI polyisocyanate described therein and 140 g (0.28 val) of the polyethylene oxide polyether described therein are reacted in the presence of 0.01 g of zinc(II) 2-ethyl-1-hexanoate as allophanatisation catalyst to give a colourless, clear polyisocyanate mixture having the following characteristic data:

| | |
|---|---|
| Solids content: | 100% |
| NCO content: | 16.2% |
| NCO functionality: | 4.0 |
| Viscosity (23° C.): | 6500 mPas |
| Colour index: | 60 APHA |

### Starting Polyisocyanate A)-5 Containing Emulsifier Type D4):

According to the process described for starting polyisocyanate A)-1, 980 g (5.06 val) of the isocyanurate-group-containing, HDI polyisocyanate described therein, 20 g (0.09 val) of CAPS, 11 g (0.09 mol) of dimethylcyclohexylamine are reacted to give a colourless, clear polyisocyanate mixture having the following characteristic data:

| | |
|---|---|
| Solids content: | 100% |
| NCO content: | 20.6% |
| NCO functionality: | 3.4 |
| Viscosity (23° C.): | 5400 mPas |
| Colour index: | 40 APHA |

### Starting Polyisocyanate A)-6 Containing Emulsifier Type D5):

890 g (4.60 val) of the isocyanurate-group-containing, HDI-based polyisocyanate described in the preparation of starting polyisocyanate A)-1 are stirred for 12 hours at 80° C.. with 110 g of an emulsifier mixture consisting of 97 g of an ethoxylated tridecyl alcohol phosphate (Rhodafac® RS-710, Rhodia) and 13 g of dimethylcyclohexylamine as neutralising amine. After cooling to room temperature, a colourless, clear polyisocyanate mixture having the following characteristic data is obtained:

| | |
|---|---|
| Solids content: | 100% |
| NCO content: | 19.3% |
| NCO functionality: | 3.5 |
| Viscosity (23° C.): | 3000 mPas |
| Colour index: | 30 APHA |

### Starting Polyisocyanate A1-1

Isocyanurate-group-containing polyisocyanate based on 1,6-diisocyanatohexane (HDI) having an NCO content of 23±0.5%, a content of monomeric HDI of ≦0.2%, a colour index <40 and a viscosity of 1200±300 mPas (23° C..).

### Starting Polyisocyanate A1-2

Iminooxadiazinedione-group-containing, HDI-based polyisocyanate having an NCO content of 23.5±0.5%, a content of monomeric HDI of <0.3%, a colour index <40 and a viscosity of 700±100 mPas (23° C..).

### EXAMPLES

### Example 1

N-(3-Trimethoxysilylpropyl)aspartic acid diethyl ester was prepared, according to the teaching of U.S. Pat. No. 5,364,955, Example 5, by reacting equimolar amounts of 3-aminopropyltrimethoxysilane and maleic acid diethyl ester.

### Example 2

1287.5 g of starting polyisocyanate A)-1 in 700 g of methyl ethyl ketone were placed at room temperature in a standard stirring apparatus, and nitrogen was passed over at a rate of 2 litres/hour. Then, in the course of 2 hours, while stirring at room temperature, 112.5 g (0.05 val) of the alkoxysilane from Example 1 in 700 g of methyl ethyl ketone were added dropwise until the theoretical NCO content was reached. During the addition, the temperature was kept at a maximum of 40° C.

1279.5 g of the polyisocyanate so modified with alkoxysilane were mixed with 220.5 g of Nissan Organosol MEK-ST and adjusted to a solids content of 100% in a rotary evaporator at 60° C. and 120 mbar.

A transparent, liquid polyisocyanate having the following characteristic data was obtained: solids content 100 wt. %, NCO content 15.99%, viscosity 12,700 mPas (23° C.), particle size 54.2 nm, 10% SiO₂ content.

### Example 3

1106.6 g of starting polyisocyanate A)-1 were placed at room temperature in a standard stirring apparatus, and nitrogen was passed over at a rate of 2 litres/hour. Then, in the course of 2 hours, at room temperature, 193.4 g (0.1 val) of the alkoxysilane from Example 1 were added dropwise until the theoretical NCO content was reached. During the addition, the temperature was kept at a maximum of 40° C.

1080 g of the polyisocyanate so modified with alkoxysilane were mixed with 378.5 g of Nissan Organosol MEK-ST and adjusted to a solids content of 100% in a rotary evaporator at 60° C. and 120 mbar.

A translucent, liquid polyisocyanate having the following characteristic data was obtained: solids content 100 wt. %, NCO content 13.3%, viscosity 24,900 mPas (23° C.), particle size 54.6 nm, 10% SiO₂ content.

### Example 4

466.1 g of starting polyisocyanate A)-2 in 250 g of methyl ethyl ketone were placed at room temperature in a standard stirring apparatus, and nitrogen was passed over at a rate of 2 litres/hour. Then, in the course of 2 hours, while stirring at room temperature, 33.9 g (0.05 val) of the alkoxysilane from Example 1 in 250 g of methyl ethyl ketone were added dropwise until the theoretical NCO content was reached. During the addition, the temperature was kept at a maximum of 40° C.

508.4 g of the polyisocyanate so modified with alkoxysilane were mixed with 91.6 g of Nissan Organosol MEK-ST and adjusted to a solids content of 100% in a rotary evaporator at 60° C. and 120 mbar.

A transparent, liquid polyisocyanate having the following characteristic data was obtained: solids content 100 wt. %, NCO content 13.22%, viscosity 7400 mPas (23° C.), particle size 31.4 nm, 10% SiO₂ content.

### Example 5

465.0 g of starting polyisocyanate A)-3 in 250 g of methyl ethyl ketone were placed at room temperature in a standard stirring apparatus, and nitrogen was passed over at a rate of 2 litres/hour. Then, in the course of 2 hours, while stirring at room temperature, 34.99 g (0.05 val) of the alkoxysilane from Example 1 in 250 g of methyl ethyl ketone were added dropwise until the theoretical NCO content was reached. During the addition, the temperature was kept at a maximum of 40° C.

937.2 g of the polyisocyanate so modified with alkoxysilane were mixed with 162.8 g of

Nissan Organosol MEK-ST and adjusted to a solids content of 100% in a rotary evaporator at 60° C. and 120 mbar.

A transparent, liquid polyisocyanate having the following characteristic data was obtained: solids content 100 wt. %, NCO content 13.5%, viscosity 17,100 mPas (23° C.), particle size 46.7 nm, 10% SiO₂ content.

### Example 6

468.3 g of starting polyisocyanate A)-4 in 250 g of methyl ethyl ketone were placed at room temperature in a standard stirring apparatus, and nitrogen was passed over at a rate of 2 litres/hour. Then, in the course of 2 hours, while stirring at room temperature, 31.7 g (0.05 val) of the alkoxysilane from Example 1 in 250 g of methyl ethyl ketone were added dropwise until the theoretical NCO content was reached. During the addition, the temperature was kept at a maximum of 40° C.

510 g of the polyisocyanate so modified with alkoxysilane were mixed with 90 g of Nissan Organosol MEK-ST and adjusted to a solids content of 100% in a rotary evaporator at 60° C. and 120 mbar.

A transparent, liquid polyisocyanate having the following characteristic data was obtained: solids content 100 wt. %, NCO content 12.55%, viscosity 16,300 mPas (23° C.), particle size 34.6 nm, 10% SiO₂ content.

### Example 7

472.7 g of starting polyisocyanate A)-5 in 250 g of methyl ethyl ketone were placed at room temperature in a standard stirring apparatus, and nitrogen was passed over at a rate of 2 litres/hour. Then, in the course of 2 hours, while stirring at room temperature, 27.3 g (0.05 val) of Dynasilan 1189 in 250 g of methyl ethyl ketone were added dropwise until the theoretical NCO content was reached. During the addition, the temperature was kept at a maximum of 40° C.

935 g of the polyisocyanate so modified with alkoxysilane were mixed with 165 g of Nissan Organosol MEK-ST and adjusted to a solids content of 100% in a rotary evaporator at 60° C. and 120 mbar.

A transparent, liquid polyisocyanate having the following characteristic data was obtained: solids content 100 wt. %, NCO content 16.14%, viscosity 17,700 mPas (23° C.), particle size 68.9 nm, 10% SiO₂ content.

### Example 8

467.3 g of starting polyisocyanate A)-6 in 350 g of butyl acetate were placed at room temperature in a standard stirring apparatus, and nitrogen was passed over at a rate of 2 litres/hour. Then, in the course of 2 hours, while stirring at room temperature, 32.7 g (0.05 val) of the alkoxysilane from Example 1 in 150 g of butyl acetate were added dropwise until the theoretical NCO content was reached. During the addition, the temperature was kept at a maximum of 40° C.

466.8 g of the polyisocyanate so modified with alkoxysilane were mixed with 79.6 g of Nissan Organosol MEK-ST and adjusted to a solids content of 100% in a rotary evaporator at 60° C. and 120 mbar.

A transparent, liquid polyisocyanate having the following characteristic data was obtained: solids content 100 wt. %, NCO content 13.16%, viscosity 7400 mPas (23° C.), particle size 21.4 nm, 10% SiO₂ content.

### Example 9

466.1 g of starting polyisocyanate A)-2 in 250 g of methoxypropyl acetate were placed at room temperature in a standard stirring apparatus, and nitrogen was passed over at a rate of 2 litres/hour. Then, in the course of 2 hours, while stirring at room temperature, 33.9 g (0.05 val) of the alkoxysilane from Example 1 in 250 g of methoxypropyl acetate were added dropwise until the theoretical NCO content was reached. During the addition, the temperature was kept at a maximum of 40° C.

481.6 g of the polyisocyanate so modified with alkoxysilane were mixed with 268.4 g of Nissan Organosol MEK-ST and adjusted to a solids content of 65% in a rotary evaporator at 60° C. and 120 mbar. Then 750 ml of methoxypropyl acetate were added and the solids content was again adjusted to 65% in a rotary evaporator at 60° C. and 120 mbar.

A transparent, liquid polyisocyanate having the following characteristic data was obtained: solids content 69.1 wt. %, NCO content 7.23%, viscosity 162 mPas (23° C.), particle size 29.2 nm, 26% SiO₂ content in the solid.

### Example 10 (Comparison)

397.5 g of starting polyisocyanate A1-1 in 250 g of butyl acetate were placed at room temperature in a standard stirring apparatus, and nitrogen was passed over at a rate of 2 litres/hour. Then, in the course of 2 hours, while stirring at room temperature, 102.5 g (0.2 val) of Dynasilan 1189 in 250 g of butyl acetate were added dropwise until the theoretical NCO content was reached. During the addition, the temperature was kept at a maximum of 40° C.

936 g of the polyisocyanate so modified with alkoxysilane were mixed with 164 g of Nissan Organosol MEK-ST and adjusted to a solids content of 100% in a rotary evaporator at 60° C. and 120 mbar.

A transparent, liquid polyisocyanate having the following characteristic data was obtained:

solids content 100 wt. %, NCO content 12.3%, viscosity 8100 mPas (23° C.), particle size 32.8 nm, 10% SiO₂ content in the solid.

### Example 11 (Comparison)

883.6 g of starting polyisocyanate A1-2 in 500 g of methyl ethyl ketone were placed at room temperature in a standard stirring apparatus, and nitrogen was passed over at a rate of 2 litres/hour. Then, in the course of 2 hours, while stirring at room temperature, 116.4 g (0.1 val) of Dynasilan 1189 in 500 g of methyl ethyl ketone were added dropwise until the theoretical NCO content was reached. During the addition, the temperature was kept at a maximum of 40° C.

939.4 g of the polyisocyanate so modified with alkoxysilane were mixed with 160.6 g of Nissan Organosol MEK-ST and adjusted to a solids content of 100% in a rotary evaporator at 60° C. and 120 mbar.

A transparent, liquid polyisocyanate having the following characteristic data was obtained: solids content 100 wt. %, NCO content 15.9%, viscosity 3250 mPas (23° C.), particle size 40.2 nm, 10% SiO₂ content in the solid.

### Example 12 Lacquer Formulations Clear Lacquer

| | 1 | 2 | 3 | 4 | 5 | 6 |
|---|---|---|---|---|---|---|
| Polyol Bayhydrol type | XP 2645 | XP 2645 | XP 2470 | XP 2470 | XP 2695 | XP 2695 |
| Solids % | 43 | 43 | 45 | 45 | 41 | 41 |
| OH % | 4.5 | 4.5 | 3.9 | 3.9 | 5.00 | 5.00 |
| Polyisocyanate | A)-5 | Ex. 7 | A)-5 | Ex. 7 | A)-5 | Ex. 7 |
| Solids % | 100 | 100 | 100 | 100 | 100 | 100 |
| NCO % | 20.6 | 16.14 | 20.6 | 16.14 | 20.6 | 16.14 |
| SiO2 content in the PIC % | 0 | 10 | 0 | 10 | 0 | 10 |
| NCO: OH | 1.5 | 1.5 | 1.5 | 1.5 | 1.5 | 1.5 |
| Component 1 | | | | | | |
| XP 2645 | 89.0 | 100.0 | | | | |
| XP 2470 | | | 101.6 | 91.2 | | |
| XP 2695 | | | | | 99.9 | 88.4 |
| Surfynol 104 BC (delivery form 50%) | 2.3 | 2.3 | 2.3 | 2.3 | 2.3 | 2.3 |
| Borchigel PW 25 (delivery form 25%) | 0.3 | 0.3 | 0.3 | 0.3 | 0.3 | 0.3 |
| Baysilone 3468 (10% in solution in BG) | 1.9 | 1.9 | 1.9 | 1.9 | 1.9 | 1.9 |
| Tinuvin 292 | 0.8 | 0.8 | 0.8 | 0.8 | 0.8 | 0.8 |
| Tinuvin 1130 | 1.6 | 1.6 | 1.6 | 1.6 | 1.6 | 1.6 |
| demin. H20 to DIN 6 40 sec. | 10.1 | 10.0 | 10.0 | 8.1 | 10.8 | 9.3 |
| Total comp. 1 | 106.0 | 116.9 | 118.5 | 106.2 | 117.6 | 104.6 |
| Component 2 | | | | | | |
| Ex. 7 (80% in 3-methoxy-n-butyl acetate) | | 55.5 | | 46.0 | | 52.0 |
| Ex. A)-5 (80% in 3-methoxy-n-butyl acetate) | 38.7 | | 40.1 | | 46.1 | |
| Total comp. 1 + 2 | 144.7 | 172.4 | 158.6 | 152.2 | 163.7 | 156.5 |
| demin. H2O to spraying viscosity | 33.0 | 45.4 | 33.5 | 30.3 | 37.3 | 35.9 |
| Spraying viscosity DIN 4 (about 25 sec.) | 24.0 | 23.0 | 22.0 | 26.0 | 25.0 | 22.0 |
| Solids in % | 41.1 | 41.9 | 42.5 | 44.7 | 40.6 | 42.4 |
| Nano content in the solid (%) | 0.0 | 4.9 | 0.0 | 4.5 | 0.0 | 5.1 |

### Comparison Examples 12.1, 12.3, 12.5; Examples 12.2, 12.4, 12.6 According to the Invention

The polyol mixture was placed in a reaction vessel in each case; the additives and light stabiliser were added and the whole was mixed thoroughly, with stirring. It was then adjusted to a runout viscosity of 40 seconds (DIN 6 beaker) with demineralised water. After a stirring time of one day (for deaeration), the polyisocyanate/solvent mixture was added, and the mixture was stirred thoroughly again and adjusted to a spraying viscosity of 25 seconds (DIN 4 beaker) with demineralised water.

The lacquer was then applied to the prepared substrate using a Sata Digital RP 2 gravity spray gun (1.4 mm nozzle) in 1.5 cross-coats. After an aeration time of 30 minutes, the lacquer was dried at 60° C. for 30 minutes. The dry layer thickness was in each case approximately from 50 to 60 μm.

### Example 13 Lacquer Testing Clear Lacquers from Example 12

| | 1 | 2 | 3 | 4 | 5 | 6 |
|---|---|---|---|---|---|---|
| Polyol | XP 2645 | XP 2645 | XP 2470 | XP 2470 | XP 2695 | XP 2695 |
| Polyisocyanate | A)-5 | Ex. 7 | A)-5 | Ex. 7 | A)-5 | Ex. 7 |
| SiO2 content in the PIC % | 0 | 10 | 0 | 10 | 0 | 10 |
| Drying [h] | | | | | | |
| T1 | 2 | 2 | 1.5 | 1.5 | 1.5 | 1.5 |
| T2 | 5.5 | 5.5 | 4 | 5 | 4 | 4 |
| T3 | >6 | >6 | 5.5 | 5.5 | 5.5 | 5.5 |
| T4 | >6 | >6 | >6 | >6 | >6 | >6 |
| Layer thickness in μm | 46.0 | 48.0 | 60.0 | 60.0 | 52.0 | 60.0 |
| Gloss | 86.6 | 86.9 | 86.6 | 87.0 | 82.9 | 85.1 |
| Haze | 12.7 | 8.9 | 8.0 | 6.1 | 29.5 | 21.6 |
| Scratch resistance hammer test/steel wool | | | | | | |
| Residual gloss after exposure | 37.8 | 45.3 | 47.4 | 52.5 | 47.5 | 53.0 |
| Residual gloss after reflow (2 h 60° C.) | 75.4 | 80.3 | 77.6 | 79.3 | 72.1 | 81.5 |
| Rel. residual gloss after exposure [%] | 43.6 | 52.1 | 54.7 | 60.3 | 57.3 | 62.3 |
| Rel. residual gloss after reflow (2 h 60° C.) [%] | 87.1 | 92.4 | 89.6 | 91.1 | 87.0 | 95.8 |
| Pendulum hardness R.T. in sec. | | | | | | |
| 2 h R.T. | 30 | 24 | 25 | 18 | 27 | 21 |
| 1 d R.T. | 175 | 175 | 115 | 78 | 146 | 125 |
| 7 d R.T. | 184 | 184 | 110 | 73 | 128 | 113 |
| Scratch resistance Amtec Kistler | | | | | | |
| Residual gloss after 10 cycles | 64.5 | 72.0 | 61.8 | 62.8 | 60.2 | 67.4 |
| Residual gloss after reflow (2 h 60° C.) | 77.5 | 81.1 | 72.5 | 77.0 | 69.2 | 75.7 |
| Rel. residual gloss after exposure [%] | 74.5 | 82.9 | 71.4 | 72.2 | 72.6 | 79.2 |
| Rel. residual gloss after reflow (2 h 60° C.) [%] | 89.5 | 93.3 | 83.7 | 88.5 | 83.5 | 89.0 |
| Chemical resistance | | | | | | |
| Rating after 2 h \| 1 d \| 7 d | | | | | | |
| Water (1 h action) | 2/2/2 | 2/2/2 | 2/2/2 | 2/2/2 | 2/2/2 | 2/2/2 |
| Xylene | 4/2/1 | 4/2/1 | 4/1/1 | 4/1.5/0.5 | 4/1/0 | 3/2/0 |
| MPA | 4/2/1 | 4/2/0.5 | 4/1/1 | 4/1.5/0.5 | 3.5/1.5/0 | 3/2/1 |
| Premium gasoline | 4/2/0.5 | 4/2/1 | 3/1.5/1 | 3/1.5/0.5 | 3/2/0.5 | 2.5/2/0 |
| Visual assessment after lacquering | OK | OK | OK | OK | slight | slight |
| | | | | | texture | texture |
| Visual assessment after drying | OK | OK | OK | OK | slight | slight |
| | | | | | texture | texture |

Rating chemical resistance: 0-good, 5-poor

### Comparison Examples 13.1, 13.3, 13.5; Examples 13.2, 13.4, 13.6 According to the Invention

Clear-transparent, haze-free or low-haze films having an excellent film appearance and high degrees of gloss are obtained in all cases. The clear lacquers containing nano-modified hydrophilic polyisocyanates can be processed without difficulty; the nanoparticles do not adversely affect the film appearance and gloss at all.

The dry and wet scratching results of the clear lacquers nano-modified in that manner (measured as the relative gloss retention after exposure, see above) are about 5 to 15% above those of the unmodified variant in each case. The assessments of chemical resistance are likewise improved.

### Example 14 Lacquer Formulations Single-layer Covering Lacquer White

| | 1 | 2 | 3 | 4 | 5 | 6 | 7 | 8 | 9 | 10 |
|---|---|---|---|---|---|---|---|---|---|---|
| Polyol Bayhydrol type | XP 2470 | XP 2470 | XP 2470 | XP 2470 | XP 2470 | XP 2470 | XP 2470 | XP 2470 | XP 2470 | XP 2470 |
| Solids % | 45 | 45 | 45 | 45 | 45 | 45 | 45 | 45 | 45 | 45 |
| OH % | 3.9 | 3.9 | 3.9 | 3.9 | 3.9 | 3.9 | 3.9 | 3.9 | 3.9 | 3.9 |
| Polyisocyanate | A)-1 | Ex. 2 | A)-2 | Ex. 4 | A)-3 | Ex. 5 | A)-4 | Ex. 6 | A)-5 | Ex. 7 |
| Solids % | 100 | 100 | 100 | 100 | 100 | 100 | 100 | 100 | 100 | 100 |
| NCO % | 21.2 | 15.36 | 17.4 | 13.25 | 18.2 | 23 | 16.2 | 12.34 | 20.6 | 16.14 |
| SiO2 content in the PIC % | 0.0 | 10.0 | 0.0 | 10.0 | 0.0 | 10.0 | 0.0 | 10.0 | 0.0 | 10.0 |
| NCO: OH | 1.5 | 1.5 | 1.5 | 1.5 | 1.5 | 1.5 | 1.5 | 1.5 | 1.5 | 1.5 |
| Component 1 | | | | | | | | | | |
| Bayhydrol XP 2470 | 288.1 | 249.6 | 264.7 | 231.7 | 270.1 | 293.5 | 256.1 | 223.2 | 284.7 | 255.6 |
| Surfynol 104 BC Del. | 6.5 | 6.5 | 6.5 | 6.5 | 6.5 | 6.5 | 6.5 | 6.5 | 6.5 | 6.5 |
| form (50% BA) | | | | | | | | | | |
| Borchigel PW 25 Del. | 0.9 | 0.9 | 0.9 | 0.9 | 0.9 | 0.9 | 0.9 | 0.9 | 0.9 | 0.9 |
| form (25% PG/H2O) | | | | | | | | | | |
| Baysilone LA 200 (10% BG) | 5.5 | 5.5 | 5.5 | 5.5 | 5.5 | 5.5 | 5.5 | 5.5 | 5.5 | 5.5 |
| Borchigen SN 95 Del. | 41.9 | 41.9 | 41.9 | 41.9 | 41.9 | 41.9 | 41.9 | 41.9 | 41.9 | 41.9 |
| form (25% H2O) | | | | | | | | | | |
| Tronox R-KB-4 | 174.4 | 174.4 | 174.4 | 174.4 | 174.4 | 174.4 | 174.4 | 174.4 | 174.4 | 174.4 |
| Dist. H2O DIN 6 = 20 s | 15.0 | 20.7 | 11.0 | 14.7 | 11.4 | 20.1 | 10.0 | 10.1 | 14.7 | 14.7 |
| Total comp. 1 | 532.3 | 499.5 | 504.9 | 475.6 | 510.7 | 542.8 | 495.3 | 462.5 | 528.6 | 499.5 |
| Component 2 | | | | | | | | | | |
| A)-1 (80% in butoxyl) | 110.5 | | | | | | | | | |
| Ex. 2 (80% in butoxyl) | | 132.1 | | | | | | | | |
| A)-2 (80% in butoxyl) | | | 123.7 | | | | | | | |
| Ex. 4 (80% in butoxyl) | | | | 142.2 | | | | | | |
| A)-3 (80% in butoxyl) | | | | | 120.6 | | | | | |
| Ex. 5 (80% in butoxyl) | | | | | | 105.2 | | | | |
| A)-4 (80% in butoxyl) | | | | | | | 128.5 | | | |
| Ex. 6 (80% in butoxyl) | | | | | | | | 147.0 | | |
| A)-5 (80% in butoxyl) | | | | | | | | | 112.4 | |
| Ex. 7 (80% in butoxyl) | | | | | | | | | | 128.8 |
| Dynasilan Glymo | 4.4 | 4.4 | 4.4 | 4.4 | 4.4 | 4.4 | 4.4 | 4.4 | 4.4 | 4.4 |
| Tinuvin 292 | 2.2 | 2.2 | 2.2 | 2.2 | 2.2 | 2.2 | 2.2 | 2.2 | 2.2 | 2.2 |
| Total comp. 1 + 2 | 649.4 | 638.2 | 635.2 | 624.4 | 637.9 | 654.6 | 630.4 | 616.1 | 647.6 | 634.9 |
| Demin. H2O visc. to MV | 20.0 | 22.3 | 28.2 | 28.3 | 26.3 | 20.4 | 29.3 | 30.5 | 20.3 | 21.5 |
| Spraying viscosity | 25.0 | 25.0 | 24.0 | 25.0 | 23.0 | 25.0 | 24.0 | 23.0 | 22.0 | 24.0 |
| DIN4 in s | | | | | | | | | | |
| Solids in % | 58.7 | 59.2 | 57.0 | 58.4 | 57.4 | 57.7 | 57.2 | 58.6 | 58.7 | 59.7 |
| Nano content in the | 0.0 | 2.4 | 0.0 | 2.6 | 0.0 | 1.9 | 0.0 | 2.7 | 0.0 | 2.3 |
| solid (%) | | | | | | | | | | |

Butoxyl: 3-Methoxy-n-butyl acetate

### Comparison Examples 14.1, 14.3, 14.5, 14.7, 14.9; Examples 14.2, 14.4, 14.6, 14.8, 14.10 According to the Invention

The polyol mixture was placed in a reaction vessel in each case; the additives and pigment were added and the whole was mixed thoroughly, with stirring. Subsequent grinding of the pigment can be carried out in a powder mill or by means of a Skandex apparatus, grinding time from 30 to 60 minutes. The mixture was then adjusted to a runout viscosity of 20 seconds (DIN 6 beaker) with demineralised water. After a stirring time of one day (for deaeration), the polyisocyanate/solvent mixture was added, and the mixture was stirred thoroughly again and adjusted to a spraying viscosity of 25 seconds (DIN 4 beaker) with demineralised water.

The lacquer was then applied to the prepared substrate using a Sata Digital RP 2 gravity spray gun (1.4 mm nozzle) in 1.5 cross-coats. After an aeration time of 30 minutes, the lacquer was dried at 60° C. for 30 minutes. The dry layer thickness was in each case approximately 50 μm. The lacquer tests were carried out after 7 days, the anticorrosion tests after 10 days' storage at RT.

### Example 15 Lacquer Testing Single-layer Covering Lacquers White from Example 14—Anticorrosive Properties

| | 1 | 2 | 3 | 4 | 5 | 6 | 7 | 8 | 9 | 10 |
|---|---|---|---|---|---|---|---|---|---|---|
| Polyol | XP 2470 | XP 2470 | XP 2470 | XP 2470 | XP 2470 | XP 2470 | XP 2470 | XP 2470 | XP 2470 | XP 2470 |
| Polyisocyanate | A)-1 | Ex. 2 | A)-2 | Ex. 4 | A)-3 | Ex. 5 | A)-4 | Ex. 6 | A)-5 | Ex. 7 |
| SiO2 in | 0.0 | 10.0 | 0.0 | 10.0 | 0.0 | 10.0 | 0.0 | 10.0 | 0.0 | 10.0 |
| the PIC in % | | | | | | | | | | |
| Layer | 48 | 51 | 43 | 50 | 49 | 50 | 43 | 47 | 43 | 49 |
| thickness μm | | | | | | | | | | |
| Condensation | | | | | | | | | | |
| water test | | | | | | | | | | |
| after 7 d | 1/1 | 0/0 | 1/1 | 1/1 | 1/1 | 1/1 | 1/1 | 1/1 | 1/1 | 1/1 |
| after 14 d | 2/1-2 | 1/1 | 1/1-3 | 1/1 | 2/1-4 | 2/1-2 | 1/1 | 1/1-4 | 1/1 | 2/1 |
| after 21 d | 3/1-2 | 2/1-2 | 3/1-3 | 1/1-2 | 2/1-4 | 3/1-2 | 1/1 | 1/1-4 | 2/1-2 | 3/1-2 |
| after 35 d | 3/1-2 | 3/1-3 | 3/1-4 | 2/1-4 | 3/1-5 | 3/1-3 | 2/1-5 | 2/1-5 | 5/1-3 | 5/1-3 |
| after 42 d | 3/1-2 | 3/1-3 | 3/1-4 | 2/1-4 | 3/1-5 | 3/1-3 | 2/1-5 | 3/1-5 | | |
| after 49 d | 3/1-2 | 3/1-3 | 3/1-5 | 2/1-4 | 3/1-5 | 3/1-3 | 2/1-5 | 3/1-5 | | |
| after 56 d | 3/1-3 | 3/1-3 | 3/1-5 | 2/1-5 | 3/1-5 | 3/1-5 | 3/1-5 | 3/1-5 | | |
| after 70 d | 4/1-5 | 4/1-5 | 4/1-5 | 3/1-5 | 3/1-5 | 3/1-5 | 3/1-5 | 3/1-5 | | |
| after 84 d | | | | 3/1-5 | 4/1-5 | 3/1-5 | 3/1-5 | 3/1-5 | | |
| after 39 d | | | | | | | | | | |
| Salt spray | | | | | | | | | | |
| test | | | | | | | | | | |
| after 3 d | 5 | 3 | 7 | 3 // 1/1 // 1 | 8 | 5 | 7 | 5 | 10 // 1/1 // 1 | 5 |
| after 10 d | 20 | 12 | 35 | 18 // 1/1 // 1 | 15 | 18//1/1-2 //1 | 30 | 20//1/1-2//1 | 20 // 1/1 // 1 | 12 |
| after 14 d | 30 | 18 | 50 // 1/1 // 1 | 22 | 22 | 25//1/1-5//1 | 50 | 25//1/1-2/1 | 30 | 20 |
| after 21 d | 35 // 1/1-5 | 20 | 5/1-5 // 1 | 5/1-5 // 1 | 32 | 3/1-5 // 1 | 4/1-5 | 5/1-5 // 1 | 50 //1/1-5 // 1 | 25 // 1/1-3 |
| after 28 d | 4/1-5 | 30 | | | 3/1-5 | 3/1-5 // 1 | | | 5/1-5 // 1 | 30 // 1/1-5 |
| after 35 d | | 3/1-5 | | | 4/1-5 | 5/1-5 | | | | 3/1-5 |
| after 42 d | | 35 // 4/1-5 | | | | | | | | 4/1-5 |
| Pendulum | | | | | | | | | | |
| hardness | | | | | | | | | | |
| +2 h | 71 | 59 | 39 | 25 | 46 | 47 | 36 | 27 | 91 | 61 |
| after 1 d | 132 | 121 | 93 | 64 | 103 | 78 | 85 | 72 | 148 | 124 |
| after 7 d | 158 | 152 | 124 | 96 | 135 | 100 | 119 | 106 | 169 | 156 |
| Resistance | | | | | | | | | | |
| after drying, | | | | | | | | | | |
| 1 d, 7 d | | | | | | | | | | |
| Dist. H2O, 1 h | 4-5/3/1 | 4-5/3/1 | 4-5/3/1 | 4-5/3/1 | 4-5/2/1 | 4-5/3/1 | 4-5/3/1 | 4-5/3/1 | 4-5/2/1 | 4-5/2/1 |
| Premium gaso- | 5/3/2 | 5/3-4/2 | 5/4-5/2 | 5/4-5/1-2 | 5/3/2 | 5/4/2 | 5/4/2 | 5/4-5/2 | 5/2/2 | 5/2/2 |
| line, 10 min | | | | | | | | | | |
| MPA, 10 min | 5/3/1-2 | 5/3-4/1 | 5/4-5/1 | 5/4-5/1 | 5/3/1 | 5/4/2 | 5/4/1-2 | 5/4-5/2 | 5/2/1-2 | 5/2/1-2 |
| Xylene, 10 min | 5/3/1-2 | 5/3-4/1 | 5/4-5/1 | 5/4-5/1 | 5/3/1 | 5/4/2 | 5/4/1-2 | 5/4-5/1-2 | 5/2/1-2 | 5/2/1-2 |
| Gloss 20° | 81.0 | 78.9 | 82.7 | 80.3 | 81.4 | 77.9 | 78.9 | 77.7 | 79.3 | 77.5 |
| Haze | 4.1 | 4.0 | 3.4 | 3.4 | 4.0 | 3.9 | 4.0 | 4.0 | 4.9 | 5.5 |
| Hammer | | | | | | | | | | |
| scratching | | | | | | | | | | |
| steel wool. | | | | | | | | | | |
| Residual gloss | 79.5 | 78.7 | 81.3 | 79.6 | 80.1 | 76.0 | 78.1 | 77.0 | 77.9 | 77.1 |
| after 10 to- | | | | | | | | | | |
| and-fro strokes | | | | | | | | | | |
| Rel. residual | 98.1 | 99.7 | 98.3 | 99.1 | 98.4 | 97.6 | 99.0 | 99.1 | 98.2 | 99.5 |
| gloss after | | | | | | | | | | |
| 10 to-and-fro | | | | | | | | | | |
| strokes (%) | | | | | | | | | | |

### Example 16 Lacquer Testing Single-layer Covering Lacquers White from Example 14—UV Weathering CAM 180

| | 1 | 2 | 3 | 4 | 5 | 6 | 7 | 8 | 9 | 10 |
|---|---|---|---|---|---|---|---|---|---|---|
| Polyol | XP 2470 | XP 2470 | XP 2470 | XP 2470 | XP 2470 | XP 2470 | XP 2470 | XP 2470 | XP 2470 | XP 2470 |
| Polyisocyanate | A)-1 | Ex. 2 | A)-2 | Ex. 4 | A)-3 | Ex. 5 | A)-4 | Ex. 6 | A)-5 | Ex. 7 |
| SiO2 in the PIC in % | 0.0 | 10.0 | 0.0 | 10.0 | 0.0 | 10.0 | 0.0 | 10.0 | 0.0 | 10.0 |
| Layer thickness μm | 48 | 51 | 43 | 50 | 49 | 50 | 43 | 47 | 43 | 49 |
| UV accelerated | | | | | | | | | | |
| weathering CAM 180 | | | | | | | | | | |
| Gloss 60° | | | | | | | | | | |
| Starting value | 92 | 91 | 92 | 92 | 93 | 91 | 89 | 90 | 92 | 91 |
| 250 h | 90 | 89 | 88 | 86 | 89 | 88 | 86 | 87 | 92 | 90 |
| 500 h | 90 | 88 | 87 | 86 | 89 | 88 | 86 | 86 | 91 | 89 |
| 750 h | 89 | 87 | 87 | 86 | 88 | 87 | 84 | 84 | 90 | 88 |
| 1000 h | 86 | 85 | 83 | 83 | 85 | 84 | 82 | 81 | 87 | 86 |
| 1250 h | 87 | 85 | 84 | 83 | 86 | 86 | 82 | 83 | 88 | 86 |
| 1500 h | 86 | 84 | 83 | 83 | 85 | 85 | 82 | 81 | 85 | 87 |
| 1750 h | 84 | 82 | 81 | 81 | 84 | 83 | 80 | 78 | 86 | 85 |
| delta E | | | | | | | | | | |
| 250 h | 0.1 | 0.1 | 0.2 | 0.1 | 0.1 | 0.3 | 0.3 | 0.3 | 0.1 | 0.2 |
| 500 h | 0.2 | 0.1 | 0.3 | 0.1 | 0.1 | 0.3 | 0.4 | 0.2 | 0.1 | 0.1 |
| 750 h | 0.4 | 0.3 | 0.4 | 0.3 | 0.3 | 0.4 | 0.4 | 0.4 | 0.3 | 0.4 |
| 1000 h | 0.5 | 0.4 | 0.5 | 0.5 | 0.5 | 0.6 | 0.6 | 0.5 | 0.5 | 0.5 |
| 1250 h | 0.5 | 0.5 | 0.6 | 0.4 | 0.5 | 0.6 | 0.6 | 0.5 | 0.5 | 0.4 |
| 1500 h | 0.8 | 0.6 | 0.7 | 0.5 | 0.6 | 0.7 | 0.7 | 0.6 | 0.7 | 0.5 |
| 1750 h | 0.7 | 0.5 | 0.6 | 0.5 | 0.6 | 0.6 | 0.6 | 0.6 | 0.6 | 0.5 |

### Comparison Examples 16.1, 16.3, 16.5, 16.7, 16.9; Examples 16.2, 16.4, 16.6, 16.8, 16.10 According to the Invention

Rating of the salt spray test: blisters in the total area of the DIN cut (in mm)//blisters: quantity/size//rust (0-good 5-poor)

Rating of the condensation water test: blisters: quantity/size (0-good 5-poor)

Haze-free films having a good film appearance and high degrees of gloss are obtained in all cases. The covering lacquers containing nano-modified hydrophilic polyisocyanates can be processed without difficulty; the nanoparticles do not adversely affect the film appearance and the gloss at all.

The improvement in the anticorrosive properties of the lacquer films, in particular in the field of salt spray resistance, is clearly visible. The use of the nano-modified polyisocyanates according to the invention leads to significantly less damage as compared with the unmodified polyisocyanates under the same exposure, or accordingly permits considerably longer exposure times until corresponding damage is present.

The results of the CAM 180 UV accelerated weathering (Examples 16.1 to 16.10) show no negative effects of the nano-modified polyisocyanates according to the invention on the yellowing tendency (delta E) or on the reduction in gloss of the tested lacquer films. In some cases, a slightly positive trend on the yellowing of the lacquer film can be observed.

### Example 17 Viscosity Behaviour of Nanoparticle-modified Hydrophobic Polyisocyanates and of Nanoparticle-modified Hydrophilic Polyisocyanates According to the Invention

| | Starting | Viscosity |
|---|---|---|
| Polyisocyanate | polyisocyanate | ratio |
| Ex. 2 according to the invention | A)-1 | 3.6:1 |
| Ex. 4 according to the invention | A)-2 | 2.6:1 |
| Ex. 6 according to the invention | A)-4 | 2.4:1 |
| Ex. 7 according to the invention | A)-5 | 3:1 |
| Example 10 (comparison) | A1-1 | 4.6:1 |
| Example 11 (comparison) | A1-2 | 4.8:1 |

The corresponding viscosities were taken from the examples

It is known that nanoparticles increase the viscosity in polymers. However, for use in aqueous applications it is necessary to keep the viscosity of the polyisocyanates that are used as low as possible in order to facilitate their incorporability. It has been found, surprisingly, that nanoparticle-modified hydrophilic polyisocyanates according to the invention (Ex. 2, 4, 6, 7) exhibit a smaller relative viscosity increase after modification of the starting polyisocyanates as compared with analogous nanoparticle-modified polyisocyanates from DE 10 2006 054289 (Comparison Examples 10 and 11).

### Comparison Example 18 (Comparison with Example 5)

In a standard stirring apparatus, 442.8 g of starting polyisocyanate A)-3 were mixed with 157.2 g of Nissan Organosol MEK-ST and concentrated to a solids content of about 90% in a rotary evaporator at 60° C. and 120 mbar.

A cloudy, partially gelled polyisocyanate containing precipitations and having the following characteristic data was obtained: solids content about 90 wt. %, NCO content 14.5%, viscosity: could not be measured, particle size 623 nm, 10% SiO₂ content in the solid.

Comparison Example 18 shows that only in polyether-modified polyisocyanates can nanoparticles not be prepared as stable, nanoparticulate dispersions.

1.-14. (canceled)

15. A process for the preparation of nanoparticle-modified polyisocyanates, comprising
A) reacting hydrophilic polyisocyanates comprising at least one ionic and/or non-ionic emulsifier with
polyether units of formula (II) 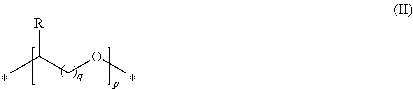
wherein
R represents hydrogen or a C1- to C10-alkyl radical and
p is a number from 1 to 1000, and
q is from 1 to 3,
and/or sulfonate groups (as SO₃),
and/or phosphate or phosphonate groups (as PO₄ or PO₃),
with
B) alkoxysilanes of formula (I)
Q-Z-SiXₐY₃₋ₐ (I)
wherein
Q represents a group reactive towards isocyanates,
X represents a hydrolysable group,
Y represents identical or different alkyl groups,
Z represents a C₁-C₁₂-alkylene group and
a is an integer from 1 to 3,
and then
C) dispersing inorganic particles, optionally in surface-modified form, having a mean particle size (Z average), determined by means of dynamic light scattering in dispersion, of less than 200 nm.

16. The process according to claim 15, wherein the hydrophilic polyisocyanates A) comprise starting polyisocyanates A1) as well as the at least one ionic and/or non-ionic emulsifier.

17. The process according to claim 16, wherein the starting polyisocyanates A1) comprise low-monomer polyisocyanates having a uretdione, isocyanurate, allophanate, biuret, iminooxadiazinedione and/or oxadiazintrione structure which are obtained by modification of the corresponding diisocyanates.

18. The process according to claim 16, wherein the starting polyisocyanates A1) comprise solely aliphatically and/or cycloaliphatically bonded isocyanate groups, which have a mean NCO functionality of from 2.0 to 5.0, a content of isocyanate groups of from 8.0 to 27.0 wt. % and a content of monomeric diisocyanates of less than 0.5 wt. %.

19. The process according to claim 16, wherein the at least one ionic and/or non-ionic emulsifier comprise reaction products D1) of the polyisocyanates A1) with hydrophilic polyether alcohols.

20. The process according to claim 16, wherein the at least one ionic and/or non-ionic emulsifier comprise reaction products D2) of monomeric diisocyanates or diisocyanate mixtures with pure polyethylene glycol monomethyl ether alcohols which contain, in the statistical mean, from 5 to 50, ethylene oxide units.

21. The process according to claim 16, wherein the at least one ionic and/or non-ionic emulsifier comprise reaction products D3) which are obtained by mixing and reacting polyether urethane emulsifiers D2) with the polyisocyanates A1) in the presence of catalysts with allophanate formation.

22. The process according to claim 16, wherein the at least one ionic and/or non-ionic emulsifier comprise reaction products D4) of the polyisocyanates A1) with 2-(cyclohexylamino)-ethanesulfonic acid and/or 3-(cyclohexylamino)-propanesulfonic acid.

23. The process according to claim 16, wherein the at least one ionic and/or non-ionic emulsifier comprise alkylphenol polyglycol ether phosphates, alkylphenol polyglycol ether phosphonates, fatty alcohol polyglycol ether phosphates, fatty alcohol polyglyol ether phosphonates, alkylphenol polyglycol ether sulfates, fatty alcohol polyglycol ether sulfates neutralised with tertiary amines, or mixtures thereof

24. The process according to claim 15, wherein, in the alkoxysilanes of formula (I),
X represents an alkoxy or hydroxy group,
Y represents a linear or branched C₁-C₄-alkyl group,
Z represents a linear or branched C₁-C₄-alkylene group, and
Q represents a group that reacts with isocyanates to form urethane, urea or thiourea.

25. A nanoparticle-modified polyisocyanate obtained by the process according to claim 15.

26. A starting component in the production of polyurethane plastics comprising the nanoparticle-modified polyisocyanates according to claim 25.

27. A polyurethane system comprising the nanoparticle-modified polyisocyanates according to claim 25.

28. The polyurethane system according to claim 27, wherein the polyurethane system is a coating composition or adhesive.
